(19) United States
(12) Patent Application Publication
(10) Pub. No.: US 2006/0164391 A1
(43) Pub. Date: Jul. 27, 2006

(54) Joystick structure for a computer USB keyboard and mouse

(76) Inventor: Er-Ta Ma, Taipei (TW)

Correspondence Address: PRO-TECTOR INTERNATIONAL SERVICES, 20775 NORADA CT., SARATOGA, CA, 95070, US

(21) Appl. No.: 11/044,801

(22) Filed: Jan. 26, 2005

(51) Int. Cl. G09G 5/08

(52) U.S. Cl. 345/161

(57) ABSTRACT

A joystick structure for a computer USB keyboard and mouse is a multi function product combining a mouse, a keyboard, a joystick, and a network phone controller. Upon plugging into a computer, the computer can detect and control the USB keyboard and press buttons of the USB mouse, and can directly control an on-line game network phone application program specific to this device to dial a network phone, answer, and query a player's phone number. An incorporated USB audio device can effectively separate game background audio signal of an audio card inside the computer with a player's voice of the USB audio card of this device, upon dialing a network phone.

### BACKGROUND OF THE INVENTION

a) Field of the Invention

The present invention relates to a joystick structure for a computer USB keyboard and mouse, and more particularly to a joystick structure which can control a mouse cursor, and allow a user to set up press buttons on a computer keyboard corresponding to those on a joystick.

b) Description of the Prior Art

Two connection cables are used to connect a conventional keyboard and a conventional mouse to serial ports of a computer, respectively, whereas a joystick is connected to a game port of a computer. The joystick is one of the input devices commonly used external to a computer, wherein press buttons such as directional keys (up, down, left, and right) and functional keys are used to activate all kinds of functions set up by computer game software or to change screen coordinates.

However, as the joystick, keyboard, and mouse are separate devices with different input ports, a user needs to change equipment just for adapting to different software system, thereby causing extreme inconvenience in usage.

Furthermore, a conventional joystick does not have function to detect a USB audio device, and cannot provide functions of dialing a network phone and querying phone number of players, either. On the other hand, for a conventional computer audio card, background audio signal of a game cannot be separated with a player's voice upon dialing a network phone, thereby interrupting the effect of voice transmission for the player.

### SUMMARY OF THE INVENTION

The primary object of the present invention is to combine a computer mouse, a keyboard, a joystick, and a network phone controller into an integrated controller which is connected to a computer via a USB interface, in order to control a mouse cursor and press buttons of a computer keyboard and to dial a network phone, answer, and query a player's phone number by directly controlling an on-line game network phone application program specific to the present invention. An interface of a supported game log-on mode can also be exchanged via a firmware program specific to the present invention, allowing for exchanging the firmware program as per the requirement of a user, thereby supporting various kinds of games.

Another object of the present invention is to incorporate a USB audio device, to effectively separate game background audio signal of a computer audio card with player's voice of a USB audio card, upon dialing a network phone with a network phone application program through the USB audio card.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of the present invention.

FIG. 2 shows a top view of the present invention.

FIG. 3 shows a plane view of the present invention.

FIG. 4 to FIG. 6 shows a circuit diagram of the present invention.

### DETAILED DESCRIPTION OF THE PREFERRED EMBODIMENTS

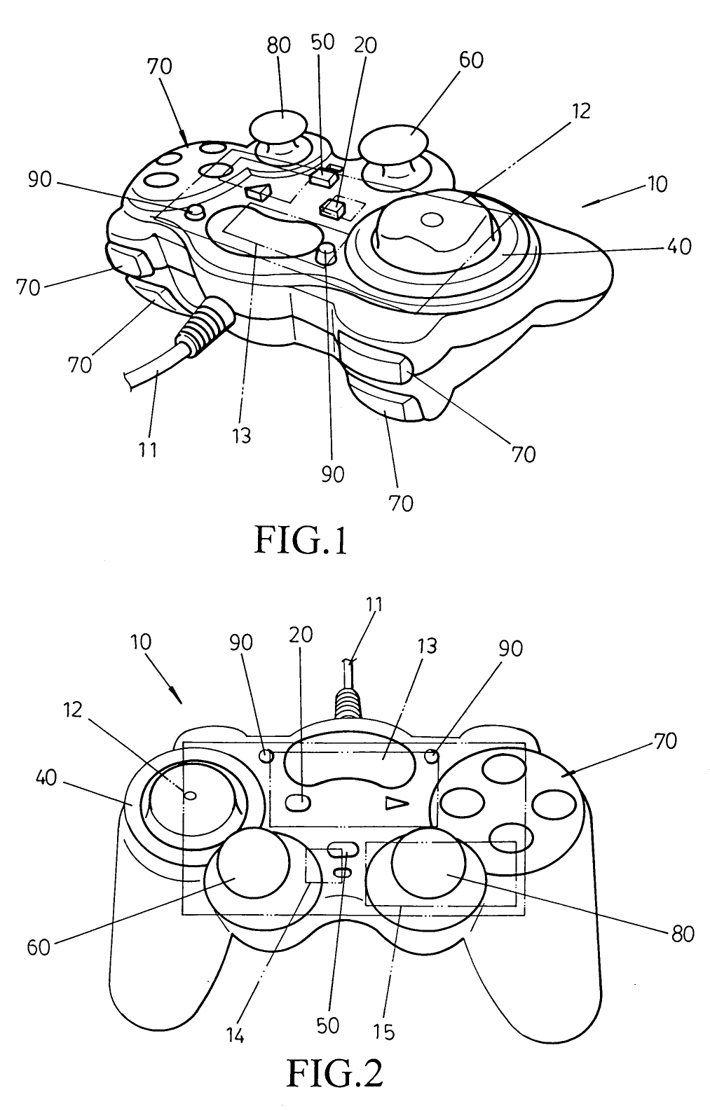

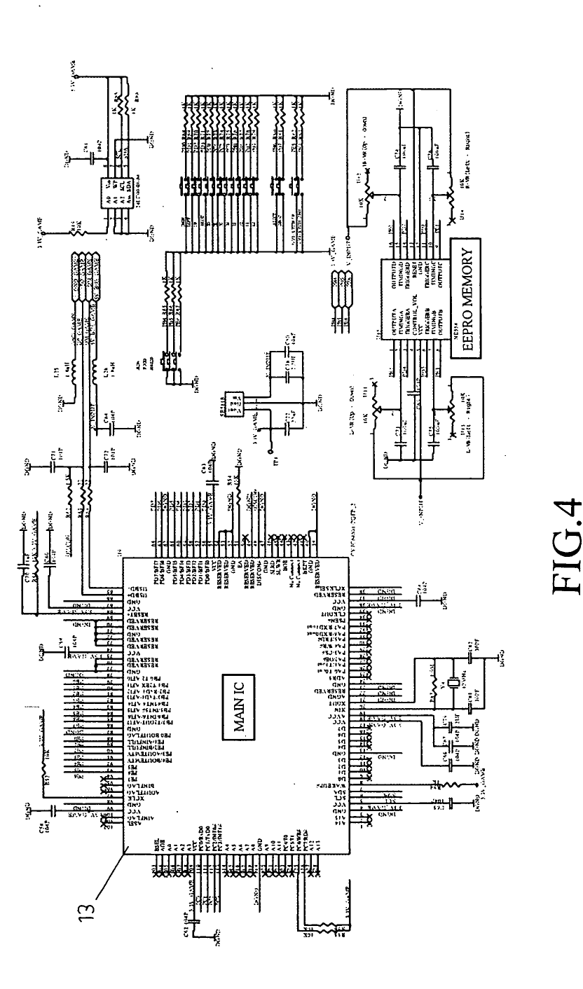

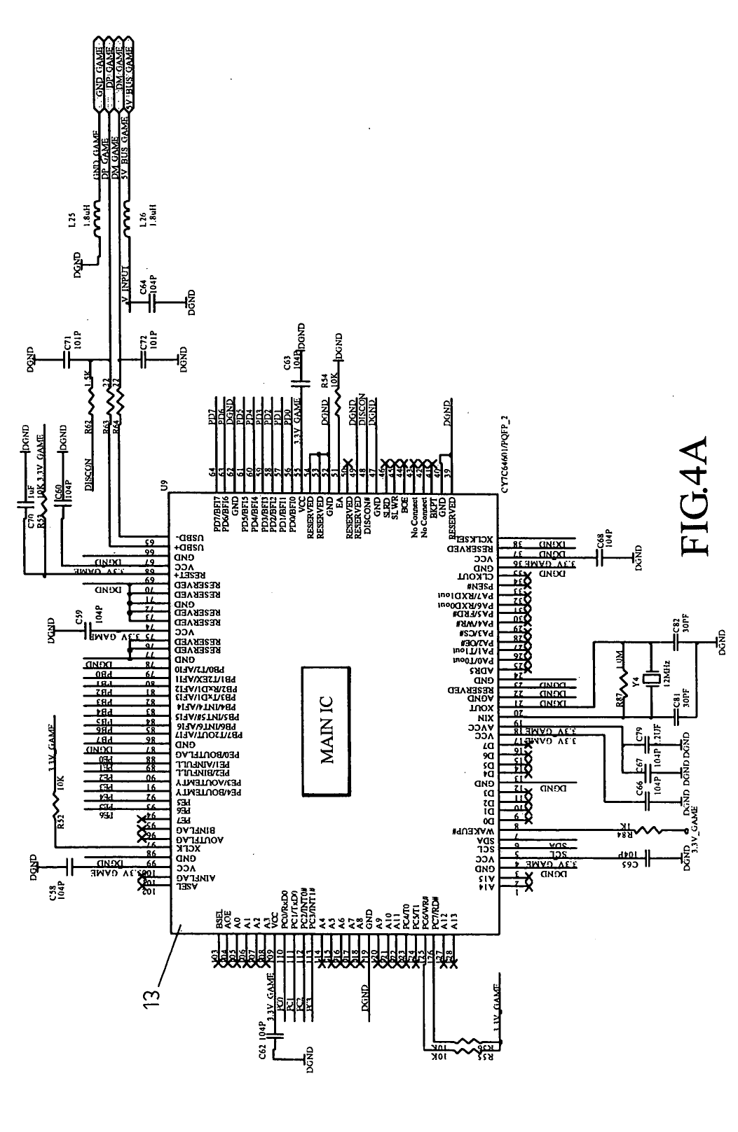

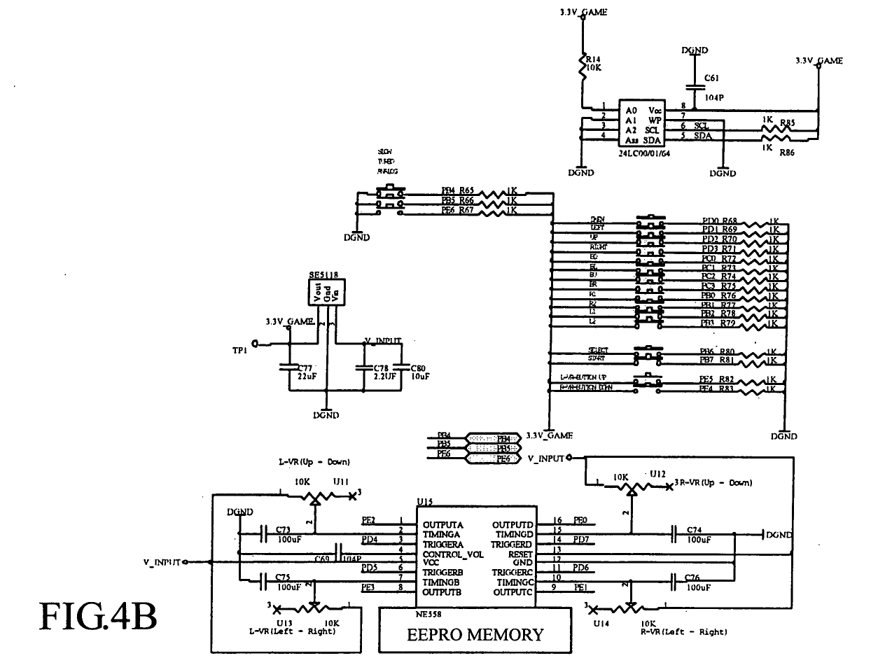

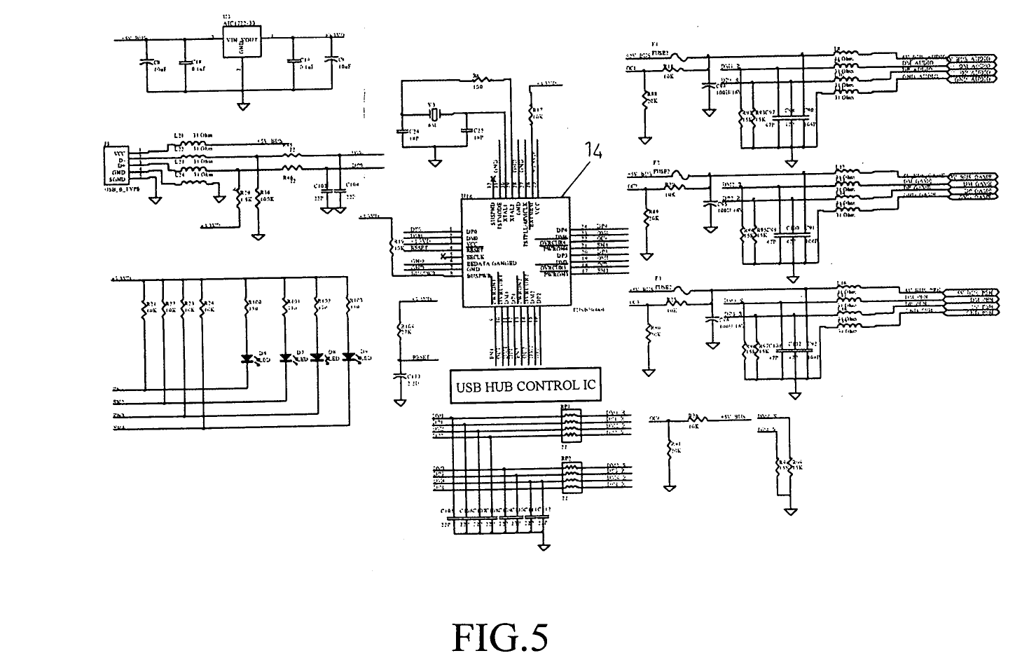

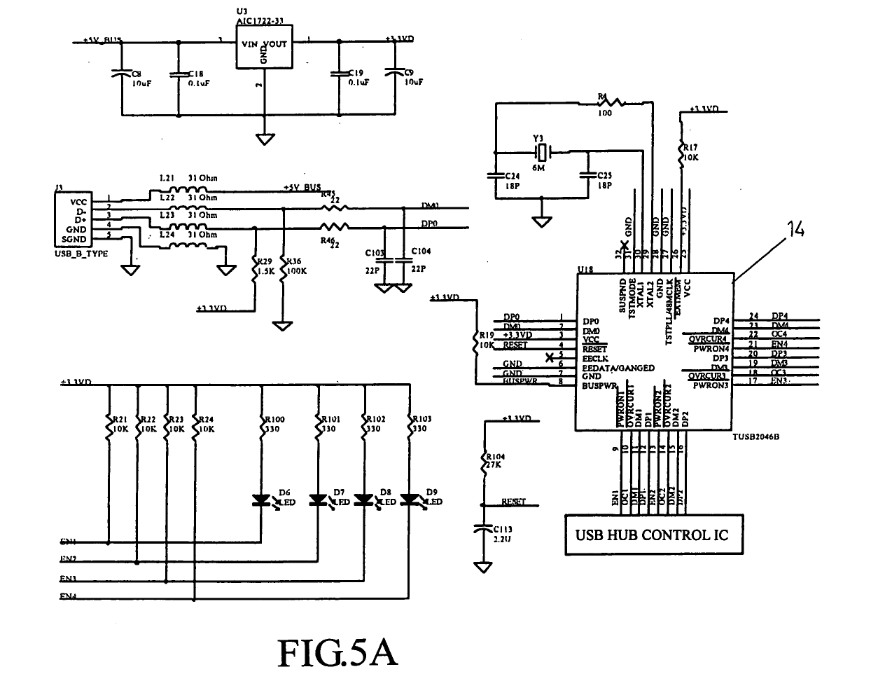

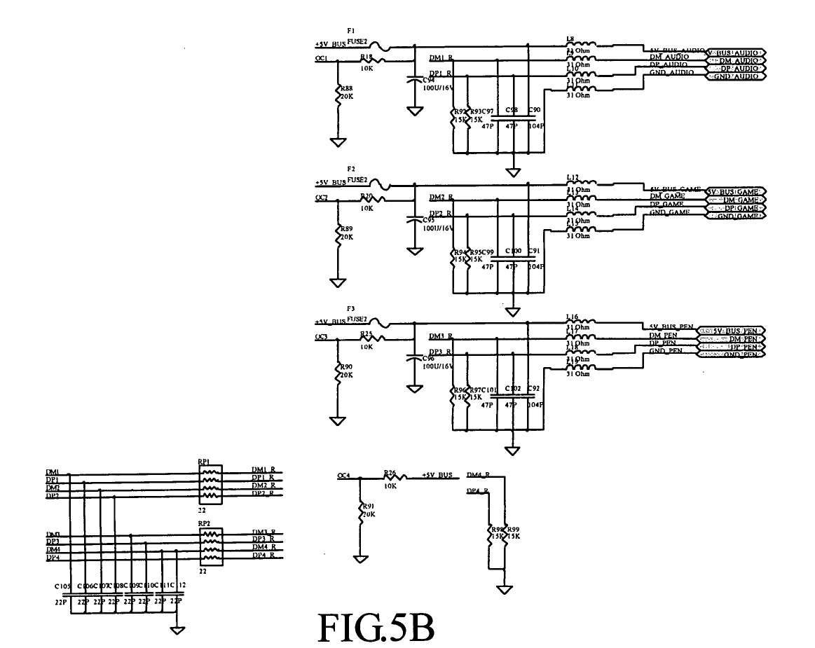

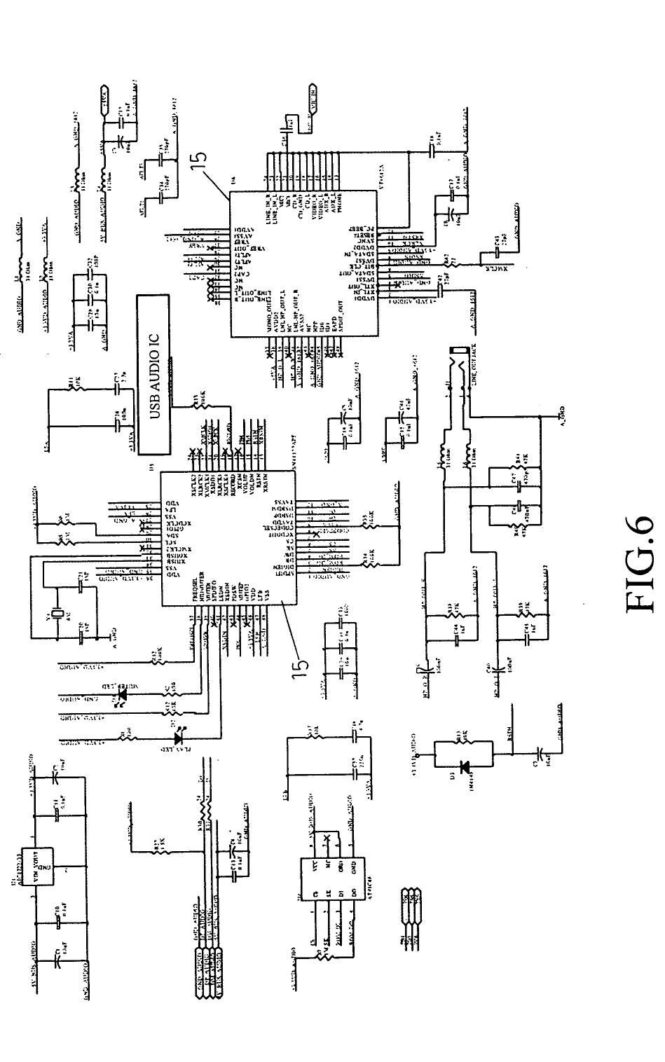

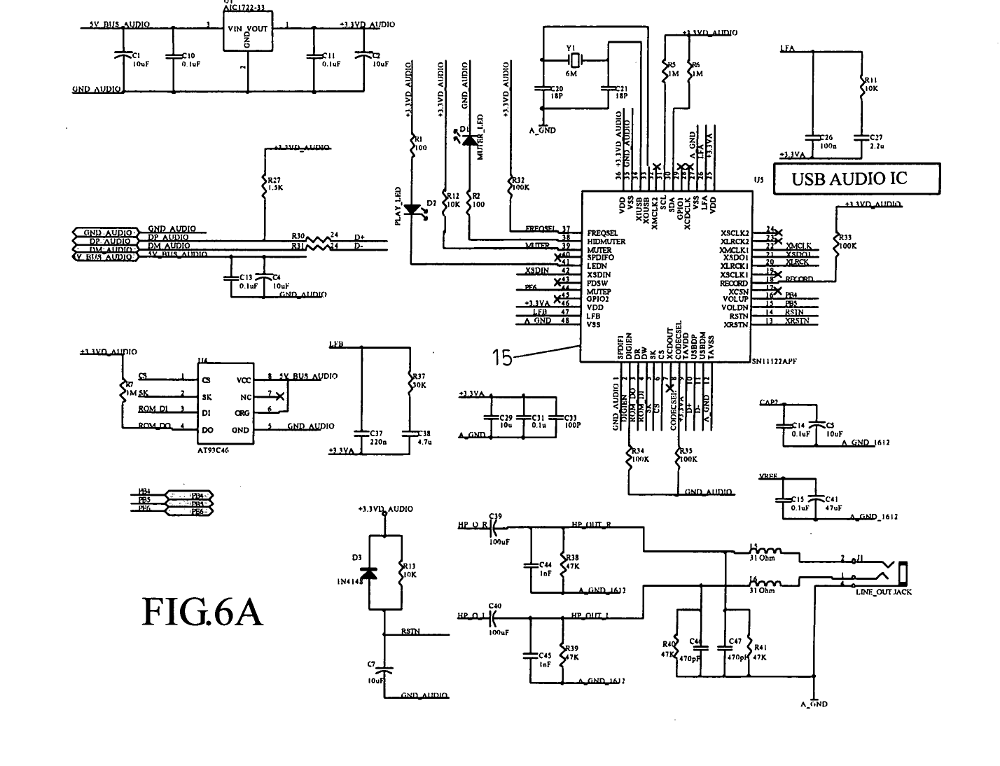

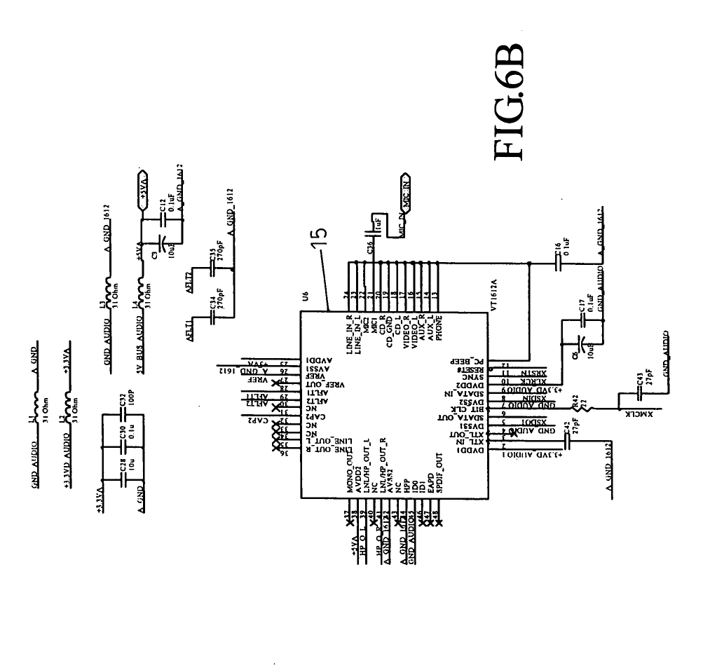

Referring to FIG. 1 to FIG. 3, a joystick 10 of the present invention is connected to a USB port of a computer with a connection cable 11. Referring to FIG. 4 to FIG. 6, a micro controller 13, a USB HUB chip 14, and a USB audio chip are installed on a PCB 12 of the present invention. A selection key 20, an activation key 30 which can activate the game log-on mode, a direction key 40, a mute key 50, a mouse function key 60, five keyboard function keys 70, a network phone dialing key 80, and two audio volume control keys 90 are installed on the joystick 10.

The selection key 20 is to provide a user to choose between the function of mouse, keyboard, or joystick of the present invention, that is, the selection key 20 serves as a switch key for mouse/keyboard/joystick functions. When the present invention is used for a USB joystick, the direction key 40, the mouse function key 60, and the keyboard function keys 70 remain the functions of a conventional joystick. When the present invention is used for a USB mouse, the mouse function key 60 can perform the functions of a conventional mouse, and a cross-shaped button of the direction key 40 can be used to control the direction of movement of a mouse cursor. The direction key 40 replaces the part of a track ball and raster of a conventional mouse, and serves as a device for generating a cursor control signal. Moving signals of X axis and Y axis can be generated, received and encoded by the micro controller 13, and transmitted to the computer via the USB interface through the connection cable 11, thereby generating a cursor displacement on a screen. When the present invention is used for a USB keyboard, a mushroom-shaped press button of the direction key 40 can be pressed to switch to the function of the cross-shaped button, that is, a user can set up press buttons of a computer keyboard corresponding to those on the joystick via a software interface. Moreover, five sets of keyboard function keys 70 can also perform the functions of press buttons of a computer keyboard.

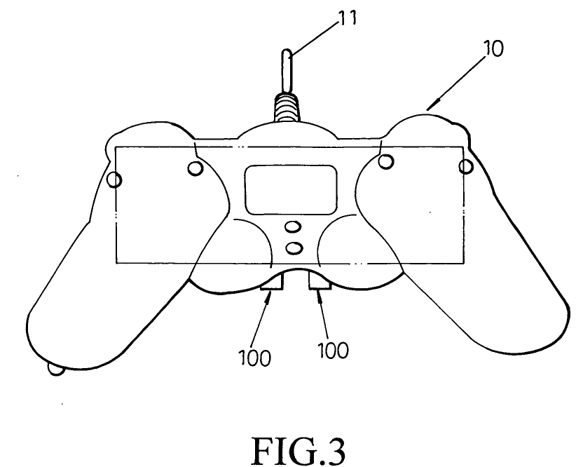

Accordingly, the present invention can directly control a specific on-line game network phone application program (LOIP; Love On-line Ip Phone) to dial a network phone, answer, and query a player's phone number. Moreover, as the present invention integrates a USB audio device, a USB audio card can be detected upon plugging into a USB port of a computer with the connection cable 11, and game background audio signal of an audio card inside the computer can be effectively separated with voice of the USB audio card of the present invention. As shown in FIG. 3, the present invention supports an earphone and a duo microphone socket 100 is installed at one end of the joystick 100, allowing a user to plug in an earphone.

Accordingly, after plugging the present invention into a computer, a USB keyboard, a USB mouse, and a USB audio device can be directly detected. In addition to providing functions of mouse and keyboard, game background audio signal of an audio card inside the computer can be effectively separated with a player's voice of the USB audio card of the present invention, upon dialing a network phone.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A joystick structure for a computer USB keyboard and mouse comprising a selection key serving as the switch key for mouse/keyboard/joystick functions; an activation key for activating a game log-on mode; a direction key for controlling a moving direction of a mouse cursor and corresponding press buttons of a compute keyboard; a mute key for stopping an audio effect; a mouse function key for providing functions of a conventional mouse; a plurality of keyboard function -keys for controlling corresponding press buttons of a computer keyboard; and a network phone dialing key for dialing a network phone, answering, and querying a player's phone number through a network phone application program.

2. The joystick structure for a computer USB keyboard and mouse according to claim 1, wherein a duo microphone socket is installed at one end of the joystick, allowing for a user to plug in an earphone.

3. The joystick structure for a computer USB keyboard and mouse according to claim 1, wherein a micro controller, a USB HUB chip, and a USB audio chip are installed on a circuit board of the joystick.
